(19) United States
(12) Patent Application Publication
(10) Pub. No.: US 2026/0141521 A1
(43) Pub. Date: May 21, 2026

(54) BIOLOGICAL SAMPLE ANALYSIS SYSTEM AND BIOLOGICAL SAMPLE ANALYSIS METHOD

(71) Applicant: Coherence Biotech Co. Ltd., Taipei (TW)

(72) Inventors: Toby Overmaat, Taipei (TW); Daniel Froeliger, Taipei (TW); I-Lun Lin, Taipei (TW)

(21) Appl. No.: 19/377,053

(22) Filed: Nov. 3, 2025

Related U.S. Application Data
(60) Provisional application No. 63/722,766, filed on Nov. 20, 2024.

(51) Int. Cl. G06T 7/00; G06T 5/50; G06T 5/60; G06T 5/70

(52) U.S. Cl. CPC G06T 7/0014; G06T 5/50; G06T 5/60; G06T 5/70; G06T 2207/10016; G06T 2207/20021; G06T 2207/20081; G06T 2207/30024; G06T 2207/30168

(57) ABSTRACT

A biological sample analysis system and a biological sample analysis method. The biological sample analysis system includes a plurality of imaging devices, a plurality of local computing devices, and a cloud computing device. Each imaging device captures a series of images from a biological sample. Actions performed by each local computing device include: receiving the series of images from a corresponding one of the imaging devices; and processing the series of images using a local machine learning model to generate an analysis result. The cloud computing device performs actions including: training a cloud machine learning model based on the series of images and the analysis result from the local computing devices to generate an optimized machine learning model; and transmitting the optimized machine learning model to each local computing device to replace or update the local machine learning model.

### CROSS-REFERENCE TO RELATED PATENT APPLICATION

This application claims the benefit of priority to the U.S. Provisional Patent Application Ser. No. 63/722,766, filed on November 20, 2024, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a system and a method, and more particularly to a biological sample analysis system and a biological sample analysis method.

### BACKGROUND OF THE DISCLOSURE

In the field of biological research, conventional biological sample analysis systems are used to efficiently analyze a biological sample. The conventional biological sample analysis systems can analyze cell images through fluorescent or luminescent markers and classical image processing to determine characteristics such as cell count, morphology, and viability. Newer methods use machine learning models to achieve this, which also sometimes removes the need for fluorescent or luminescent markers. However, the optimization efficiency of the machine learning model of the conventional biological sample analysis systems is low, which prevents the model from using a large amount of data for learning and evolving, thereby resulting in stagnation of the model performance.

### SUMMARY OF THE DISCLOSURE

In response to the above-referenced technical inadequacies, the present disclosure provides a biological sample analysis system and a biological sample analysis method.

In order to solve the above-mentioned problems, one of the technical aspects adopted by the present disclosure is to provide a biological sample analysis system. The biological sample analysis system includes a plurality of imaging devices, a plurality of local computing devices, and a cloud computing device. The imaging devices can capture a series of images from a biological sample. The local computing devices are respectively and communicatively coupled to the imaging devices. Each of the local computing devices includes a processor and a data storage, and the data storage can store a plurality of instructions. When the instructions are executed by the processor, a plurality of actions performed by the processor includes: receiving the series of images from a corresponding one of the imaging devices; and processing the series of images using a local machine learning model to generate an analysis result by identifying a status of the biological sample. The cloud computing device are communicatively coupled to each of the local computing devices. The cloud computing device performs a plurality of actions including: receiving the series of images and the analysis result from the local computing devices; training a cloud machine learning model based on the series of images and the analysis result from the local computing devices to generate an optimized machine learning model; and transmitting the optimized machine learning model to each of the local computing devices to replace or update the local machine learning model, so as to form a closed-loop feedback.

In order to solve the above-mentioned problems, another one of the technical aspects adopted by the present disclosure is to provide a biological sample analysis method. The biological sample analysis method includes: receiving the series of images from the imaging devices, respectively, via a plurality of local computing devices; processing the series of images using a local machine learning model on each of the local computing devices to generate an analysis result by identifying a status of the biological sample; receiving the series of images and the analysis result from the local computing devices via a cloud computing device; training a cloud machine learning model of the cloud computing device based on the series of images and the analysis result from the local computing devices to generate an optimized machine learning model; and transmitting the optimized machine learning model to each of the local computing devices to replace or update the local machine learning model, so as to form a closed-loop feedback.

Therefore, in the biological sample analysis system and the biological sample analysis method provided by the present disclosure, by virtue of “processing the series of images using a local machine learning model to generate an analysis result by identifying a status of the biological sample,” “training a cloud machine learning model based on the series of images and the analysis result from the local computing devices to generate an optimized machine learning model,” and “transmitting the optimized machine learning model to each of the local computing devices to replace or update the local machine learning model, so as to form a closed-loop feedback,” the biological sample analysis system and the biological sample analysis method can significantly enhance model optimization efficiency.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a biological sample analysis system according to a first embodiment of the present disclosure;

FIG. 2 is a block diagram of an imaging device according to the first embodiment of the present disclosure;

FIG. 3 is a block diagram of a local computing device according to the first embodiment of the present disclosure;

FIG. 4 is a block diagram of the biological sample analysis system according to a second embodiment of the present disclosure.

FIG. 5 is a flow diagram of steps of the biological sample analysis method according to a third embodiment of the present disclosure;

FIG. 6 is a flow diagram of steps S201 to S203 according to the third embodiment of the present disclosure;

FIG. 7 is a flow diagram of steps S301 to S305 according to the third embodiment of the present disclosure;

FIG. 8 is a schematic diagram of step S401 according to the third embodiment of the present disclosure;

FIG. 9 is a flow diagram of steps S501 to S507 according to the third embodiment of the present disclosure;

FIG. 10 is a flow diagram of steps S601 to S609 according to the third embodiment of the present disclosure;

FIG. 11 is a flow diagram of steps S701 to S707 according to the third embodiment of the present disclosure;

FIG. 12 is a flow diagram of steps S801 to S807 according to the third embodiment of the present disclosure; and

FIG. 13 is a flow diagram of steps of the biological sample analysis method according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

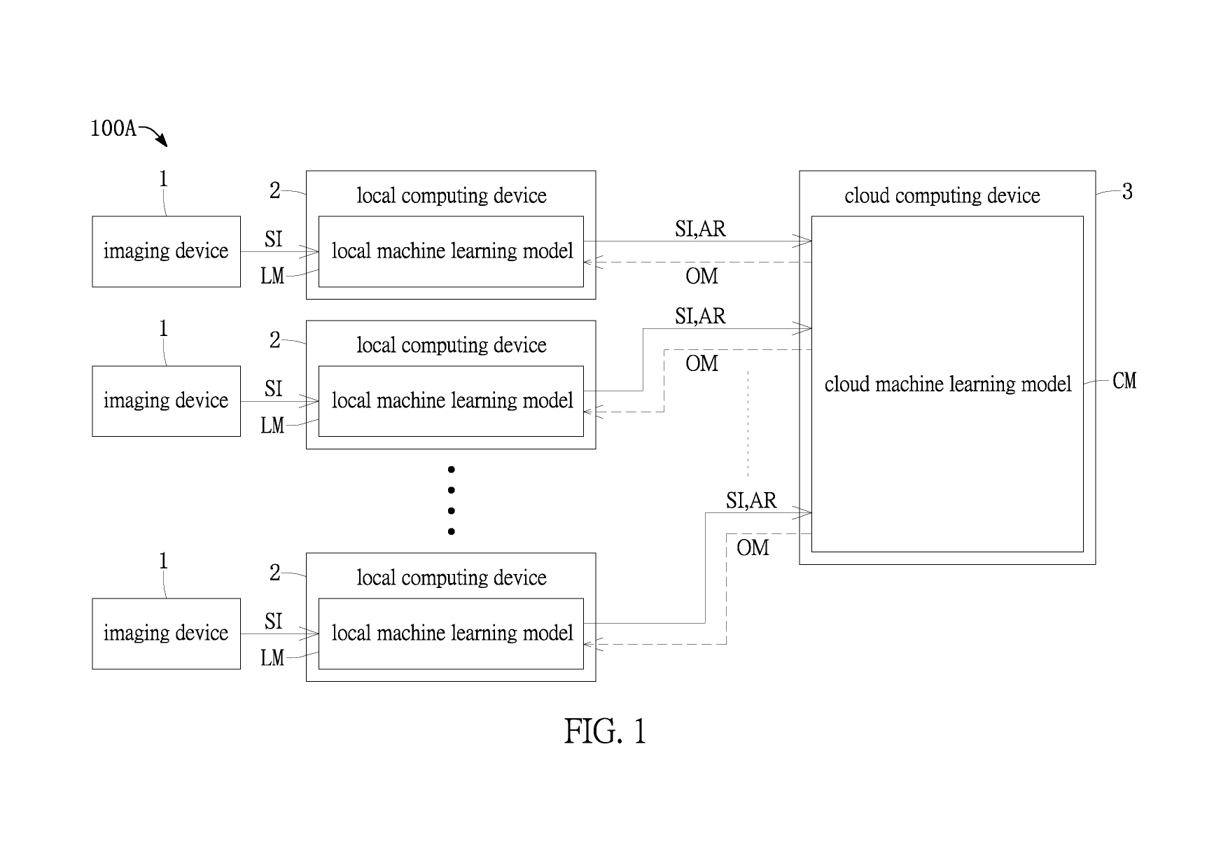

Referring to FIG. 1 to FIG. 3, a first embodiment of the present disclosure provides a biological sample analysis system 100A. As shown in FIG. 1, the biological sample analysis system 100A includes a plurality of imaging devices 1, a plurality of local computing devices 2 respectively and communicatively coupled to the imaging devices 1, and a cloud computing device 3 that is communicatively coupled to the local computing devices 2.

In practice, the imaging devices 1 and the local computing devices 2 can be deployed at different locations (e.g., different laboratories or research institutions). In the same location, the local computing device 2 can analyze image information provided by the imaging device 1 via a learning model and further share it with the cloud computing device 3.

Accordingly, the cloud computing device 3 can simultaneously and bidirectionally perform data exchange with the local computing devices 2 at the locations, thereby replacing or updating the learning model of the local computing device 2 at each of the locations to form a closed-loop feedback. That is to say, the learning model of each of the local computing devices 2 can significantly enhance model optimization efficiency. Next, the components of the biological sample analysis system 100A and their connection relationships are introduced below.

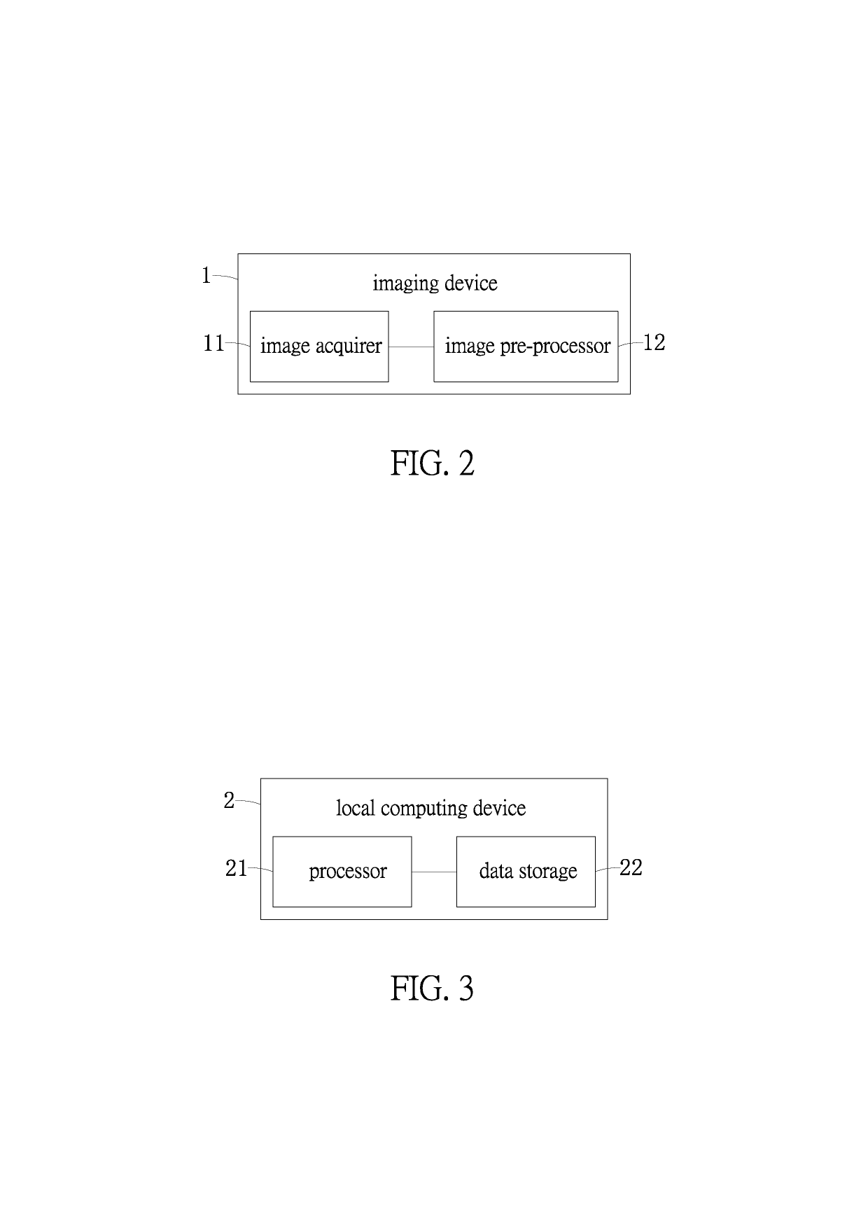

Referring again to FIG. 1 and FIG. 2, the function of each of the imaging devices 1 is to capture a series of images SI from a biological sample. In one specific application scenario, the biological sample may be cells cultured in a microfluidic chip or a multi-well plate, and the series of images SI may be digital images recording the morphology, count, or fluorescence response of the cells at specific time points. In addition, each of the imaging devices 1 may practically be an automated microscope. Each of the imaging devices 1 may be equipped with a high-resolution image sensor (e.g., CMOS or CCD), and automatically capture the biological sample at preset time intervals, thereby obtaining the series of images SI including a temporal sequence.

Preferably, in order to ensure that the series of images SI can be effectively used, each of the imaging devices 1 may include an image acquirer 11 and an image pre-processor 12 connected to the image acquirer 11.

Specifically speaking, the image acquirer 11 may be, for example, the automated microscope, and the image acquirer 11 is responsible for obtaining the initial images. In addition, the image pre-processor 12 may be a software module implemented in the local computing device 2, and the image pre-processor 12 can perform an image pre-processing operation on the initial images to obtain the series of images SI ultimately used for machine learning model analysis. The image pre-processing operation is aimed at eliminating noise and correcting deviation to enhance the accuracy of subsequent analysis. In practice, the image pre-processing operation can be implemented in various ways.

In a first aspect, the image pre-processing operation includes:

A step is implemented by obtaining a reference image. The reference image is at least one of a dark image, a flat-field image, or a dead pixel image. The dark image may be captured under completely dark conditions to capture the sensor's thermal noise points. The flat-field image may be captured against a uniform light source to correct for dark corners or brightness non-uniformity caused by optical path inconsistencies. The dead pixel image indicates the location of dead pixels on the sensor.

A step is implemented by analyzing the reference image to obtain a plurality of noise points.

A step is implemented by removing noise of each of the initial images according to the noise points, thereby forming the series of images SI.

In other words, the image pre-processor 12 first analyzes the reference image to obtain characteristics of the noise points, and performs an algorithmic process on each of the initial images according to the characteristics of the noise points.

In a second aspect, the image pre-processing operation includes: performing a background normalization on each of the initial images, so as to be integrated into the series of images SI. The image pre-processing operation in the second aspect is particularly applicable to images with non-uniform background brightness, such as the darker edge phenomenon caused by the meniscus of the culture medium. The image pre-processing operation can estimate and remove the non-uniform background through an algorithm (e.g., a rolling ball algorithm), which can make subsequent cell object detection and segmentation more accurate.

In a third aspect, the image pre-processing operation includes:

A step is implemented by obtaining a temporal sequence of the initial images.

A step is implemented by selecting an earliest one of the initial images according to the temporal sequence to be defined as a reference image.

A step is implemented by comparing a biological feature position of each of the initial images with a biological feature position of the reference image.

A step is implemented by compensating a deviation value of the biological feature position of each of the initial images relative to the biological feature position of the reference image, thereby forming the series of images SI.

In practice, in long-term live cell observation experiments, the biological sample may generate positional drift due to mechanical vibration or cell movement. Thus, the image pre-processing operation may utilize an image registration algorithm to compare the biological feature position (e.g., cell nuclei or specific structures) in each of the initial images relative to the position of the reference image, for coordinate compensation. Accordingly, in the series of images SI after the image pre-processing operation, all cells are in aligned and stable positions.

In a fourth aspect, the image pre-processing operation includes:

A step is implemented by analyzing the initial images.

A step is implemented by selecting one of the initial images that is affected by an optical diffraction limit and exhibits a blur characteristic, so as to define as a blurred image.

A step is implemented by performing a deconvolution calculation on each of the blurred images through a Point Spread Function (PSF) to obtain a reconstructed image.

A step is implemented by integrating the initial images not exhibiting the blur characteristic and the reconstructed images to form the series of images SI.

Specifically, when the size of the biological features being observed is close to the optical diffraction limit, the initial image may exhibit a blur characteristic. At this time, the biological sample analysis system 100A first analyzes and selects the images exhibiting the blur characteristic, and utilizes a known Point Spread Function (PSF) to perform deconvolution processing on the blurred images, thereby reconstructing the reconstructed images that are clearer and richer in detail. Finally, the series of images SI will be integrated jointly by the initial images not exhibiting the blur characteristic and the reconstructed images.

In a fifth aspect, the image pre-processing operation includes:

A step is implemented by selecting one of the initial images to be defined as a reference image.

A step is implemented by establishing a standard value based on an image parameter of the reference image.

A step is implemented by adjusting the initial images so that the image parameters of the initial images match the standard value.

A step is implemented by integrating the initial images that are adjusted to form the series of images SI.

Specifically, in order to ensure consistency of images from different time points or different devices, the biological sample analysis system 100A may select one of the initial images as the reference image, and establish the standard value based on an image parameter of the reference image (e.g., brightness, contrast, color distribution). Next, the other initial images are adjusted so that the image parameters of the other initial images match the standard value as closely as possible, and finally, the adjusted plurality of initial images are integrated into the series of images SI.

In a sixth aspect, the image pre-processing operation includes:

A step is implemented by obtaining a specification size of the local machine learning model.

A step is implemented by performing a resizing on each of the initial images to obtain a first size-normalized image conforming to the specification size. In response to a difference between a size of each of the initial images and the specification size being smaller than a predetermined threshold.

A step is implemented by performing an image tiling on each of the initial images to obtain a plurality of second size-normalized images conforming to the specification size. In response to the difference between the size of each of the initial images and the specification size being larger than the predetermined threshold.

A step is implemented by integrating the first size-normalized images or the second size-normalized images to form the series of images SI.

Specifically, a machine learning model typically requires input images of a fixed size. However, each of the imaging devices 1 may output the initial images with different resolutions. For this purpose, the biological sample analysis system 100A first obtains the specification size of a local machine learning model (run by the local computing device 2). In response to a difference between the size of the initial images and the specification size being smaller than a predetermined threshold, the initial images are subjected to resizing to obtain images conforming to the size (i.e., the first size-normalized images). However, when the difference is larger than the predetermined threshold (i.e., the initial images are much larger than the specification size), direct scaling down of the initial images may lose excessive details. Therefore, the biological sample analysis system 100A may perform image tiling on the initial images, so that each of the initial images is segmented into a plurality of small block images conforming to the specification size (i.e., the second size-normalized images). Finally, the size-normalized images are integrated to form the series of images SI for analysis by the local machine learning model.

It should be noted that, in practice, the image pre-processing operation may select at least one of the first aspect to the sixth aspect based on the conditions of the initial images or other requirements; that is, the image pre-processing operation may also include all the steps of the first aspect to the sixth aspect.

Referring to FIG. 1 and FIG. 3, each of the local computing devices 2 is communicatively coupled to a corresponding one of the imaging devices 1. In practice, each of the local computing devices 2 may be an edge computing unit, such as an industrial personal computer (IPC) embedded with a graphics processing unit (GPU). Each of the local computing devices 2 includes a processor 21 and a data storage 22. In practice, the data storage 22 can be implemented with either a solid-state drive (i.e., SSD) or a random-access data storage (i.e., RAM), and the data storage 22 can store a plurality of instructions. When the instructions are executed by the processor 21, actions performed by the processor 21 includes:

A step is implemented by receiving the series of images SI from a corresponding one of the imaging devices 1 (to which it is coupled).

A step is implemented by processing the series of images SI using a local machine learning model LM (pre-deployed on the local computing device 2) to generate an analysis result AR by identifying a status of the biological sample.

In detail, the local machine learning model LM can identify a specific status of the biological sample, such as determining cell viability, calculating cell confluence, or detecting the expression level of specific biomarkers, thereby generating the analysis result AR.

It should be specifically noted that the analysis result AR is generated through the calculation and analysis performed by the local computing device 2 at the location of the biological sample. Accordingly, the analysis result AR inherently possesses the advantage of low latency due to local computing, enabling the analysis result AR to provide real-time data for on-site experimental operations.

Referring to FIG. 1, the cloud computing device 3 may practically be a server cluster, and the cloud computing device 3 may be communicatively coupled to the local computing devices 2 through the Internet. The cloud computing device 3 can perform actions including:

A step is implemented by receiving the series of images SI and the analysis result AR from the local computing devices 2. That is to say, the cloud computing device 3 aggregates data from different sources globally into a remote database.

A step is implemented by training a cloud machine learning model CM (pre-deployed on the cloud computing device 3) based on the series of images SI and the analysis result AR from the local computing devices 2 to generate an optimized machine learning model OM. In other words, the cloud computing device 3 performs training or re-training on the cloud machine learning model CM based on the massive and diversified data stored in the remote database. In practice, the cloud computing device 3 is configured with powerful computing capability to process massive amounts of data, and therefore, the optimized machine learning model OM trained by the cloud computing device 3 is superior to the local machine learning model LM at any of the locations in terms of accuracy and generality.

Furthermore, to enrich the training dataset and enhance the analytical depth of the optimized machine learning model OM, the biological sample analysis system 100A is configured to capture not only image data but also a wide range of operational and environmental metadata. The metadata is sourced from the automation device 4 and various components thereof, such as motion and thermal actuators, and position and environmental sensors.

The metadata may include parameters such as temperature and incubation time, specifications of assay reagents or drug substances applied to the cells, adjustments to liquid handling flow rates, and readings from various environmental sensors.

By correlating the contextual metadata with the corresponding series of images SI, the cloud computing device 3 can analyze the interplay between cell behavior and specific experimental conditions. This integration of multi-modal data ensures that the optimized machine learning model OM is trained on a more comprehensive understanding of the entire process, thereby improving its predictive accuracy and enabling more effective protocol optimizations across connected devices.

A step is implemented by transmitting the optimized machine learning model OM to each of the local computing devices 2 to replace or update the local machine learning model LM, so as to form a closed-loop feedback. That is to say, the cloud computing device 3 transmits the optimized machine learning model OM to each of the local computing devices 2 to replace or update their original local machine learning model LM.

It should be noted that, by the aforementioned actions of "local analysis, data upload, cloud training, and model distribution," the biological sample analysis system 100A forms a closed-loop feedback for continuous learning and optimization. In other words, each of the local computing devices 2 is not only a data generator and user, but also a contributor and beneficiary of the optimization of the biological sample analysis system 100A. As time progresses and data accumulates, the analysis capability of the local computing devices 2 deployed globally will synchronously evolve and become increasingly accurate.

### Second Embodiment

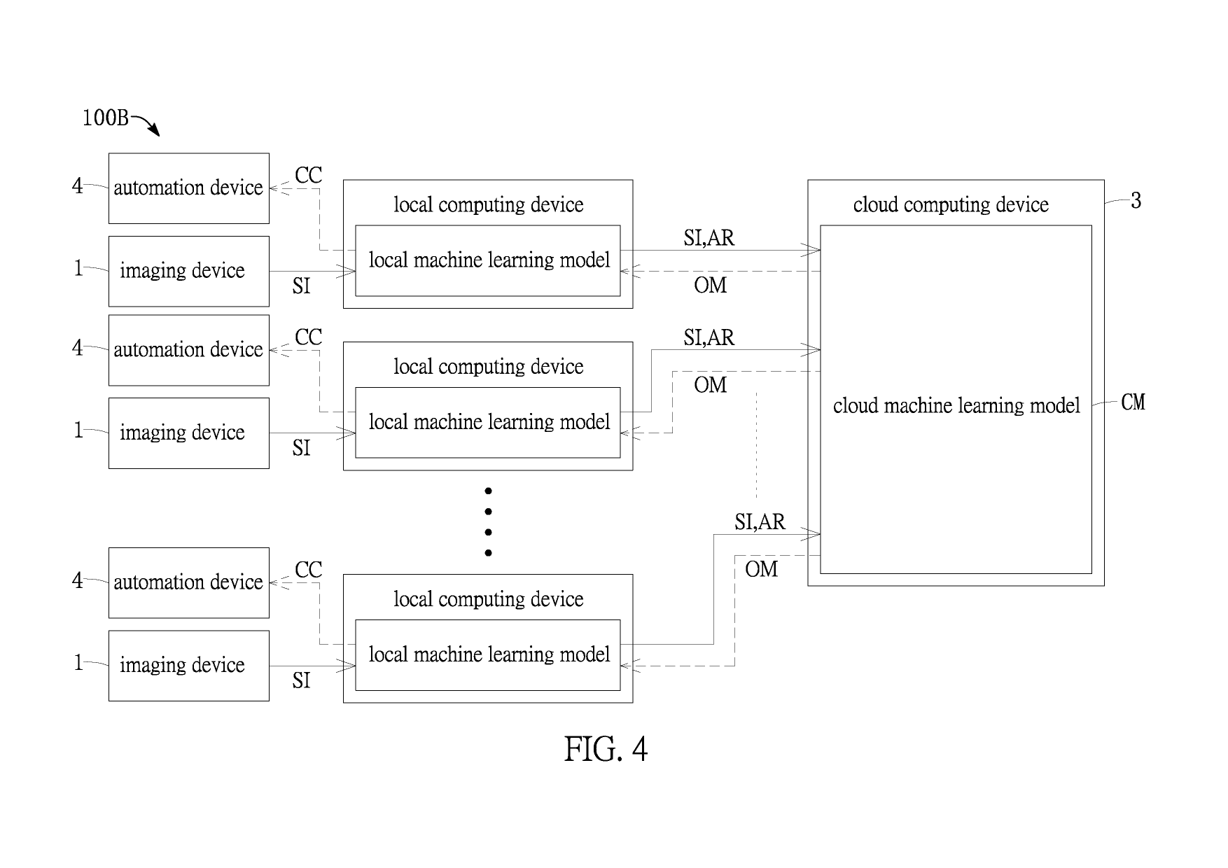

Referring to FIG. 4, a second embodiment of the present disclosure provides a biological sample analysis system 100B. The present embodiment is similar to the first embodiment, and the similarities between the present embodiment and the first embodiment will not be repeated herein. The differences of the present embodiment from the first embodiment are mainly as follows.

The biological sample analysis system 100B may further include a plurality of automation devices 4. The automation devices 4 are respectively configured at one side of the imaging devices 1 at the locations, and each of the automation devices 4 is communicatively coupled to the local computing device 2 at the same location. The automation device 4 may be a multi-instrument integration platform and includes at least one actuator (e.g., a temperature controller for precisely controlling temperature, a microfluidic pump for conveying liquid, or a motion actuator for moving a sample stage).

Furthermore, the biological sample analysis system 100B is configured such that the local machine learning models LM, executed on the local computing devices 2, can dynamically adjust the operational parameters of the actuators. For example, the local computing devices 2 may analyze the series of images and operational data using the local machine learning models LM to detect trends, changes in fluorescence intensity, or specific morphological features. Based on the analysis result, the local computing devices 2 can identify required optimizations and subsequently send commands to the automation device 4 to adjust its parameters or protocols. This enables real-time adjustments, such as regulating thermal actuators, modifying the flow rates or timing of liquid handling, and adjusting the position of the cartridge or imaging module.

In the present embodiment, after generating the analysis result AR, the local computing device 2 at each of the locations may further generate and transmit a control command CC based on the analysis result AR to the actuator of the automation device 4.

For example, when the local machine learning model LM analyzes the images and determines that the growth rate of the cell culture is irregular, possibly from the fluctuations in incubator temperature, the local computing device 2 can automatically send the control command CC to the temperature controller (i.e., the actuator) to perform temperature regulation. Taking another example, when the analysis result AR shows that rate of change of a fluorescence signal associated with a drug response crosses a threshold, the biological sample analysis system 100A can automatically send the control command CC to adjust the flow rate of the microfluidic pump (i.e., the actuator) to change the drug concentration.

Accordingly, the biological sample analysis system 100A realizes a closed-loop automation from "analysis" to "manipulation" to adjust the physical parameters of the biological sample in real time, thereby optimizing the experimental process and reducing human intervention and errors.

### Third Embodiment

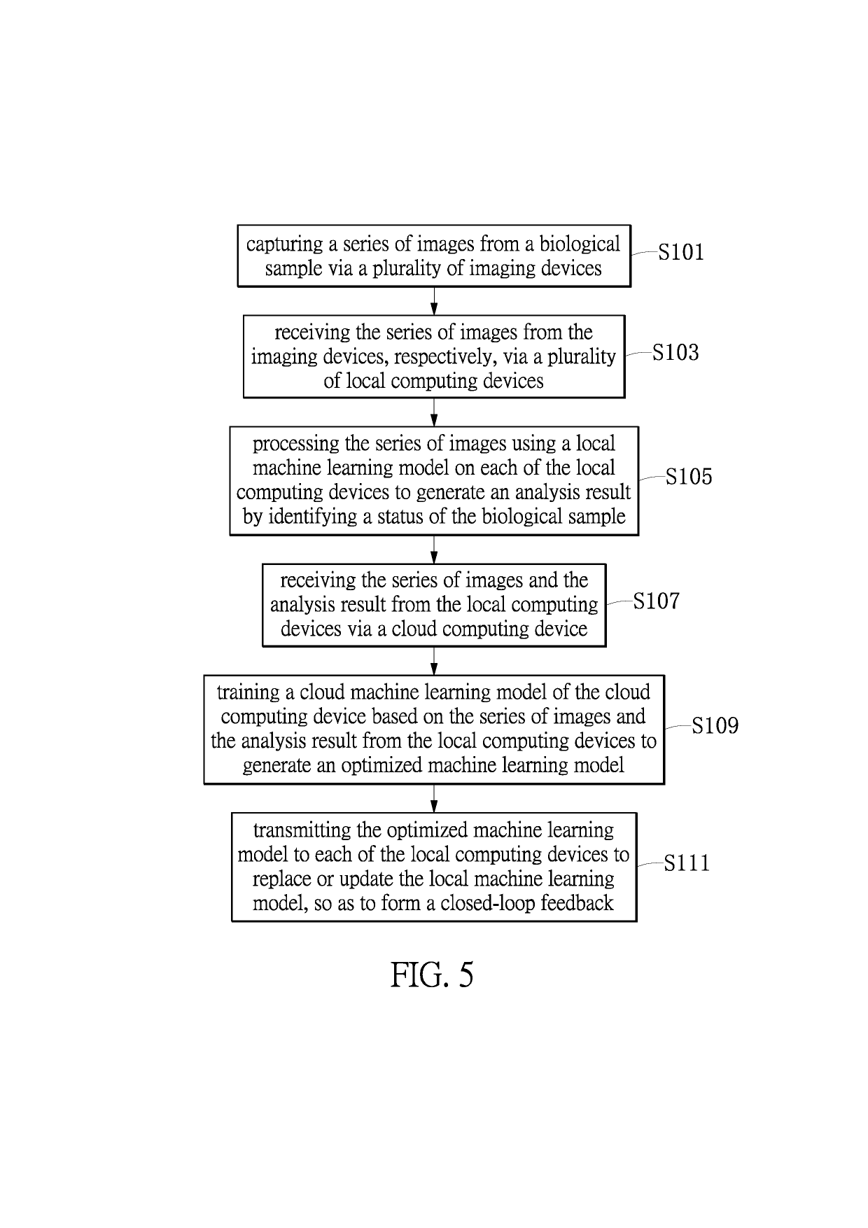

Referring to FIG. 5 to FIG. 12, a third embodiment of the present disclosure provides a biological sample analysis method. The biological sample analysis method provided in the present embodiment is applicable to the biological sample analysis systems 100A, 100B of the first embodiment to the second embodiment, and thus should be referred to with FIG. 1 to FIG. 4. As shown in FIG. 5, the present embodiment discloses a biological sample analysis method, and the biological sample analysis method includes steps S101 to S111. It should be noted that, any one of the aforementioned steps may be omitted or replaced by a reasonable variation according to the designer's requirements.

A step S101 is implemented by capturing a series of images from a biological sample via a plurality of imaging devices.

A step S103 is implemented by receiving the series of images from the imaging devices, respectively, via a plurality of local computing devices.

A step S105 is implemented by processing the series of images using a local machine learning model on each of the local computing devices to generate an analysis result by identifying a status of the biological sample.

A step S107 is implemented by receiving the series of images and the analysis result from the local computing devices via a cloud computing device.

A step S109 is implemented by training a cloud machine learning model of the cloud computing device based on the series of images and the analysis result from the local computing devices to generate an optimized machine learning model.

A step S111 is implemented by transmitting the optimized machine learning model to each of the local computing devices to replace or update the local machine learning model, so as to form a closed-loop feedback.

Preferably, as shown in FIG. 6, in order to ensure that the series of images can be effectively used, the biological sample analysis method further includes, during the process of capturing the series of images:

A step S201 is implemented by obtaining a plurality of initial images from the biological sample.

A step S203 is implemented by performing an image pre-processing operation on the initial images to obtain the series of images.

The image pre-processing operation is aimed at eliminating noise and correcting deviation to enhance the accuracy of subsequent analysis. In practice, the image pre-processing operation can be implemented in various ways.

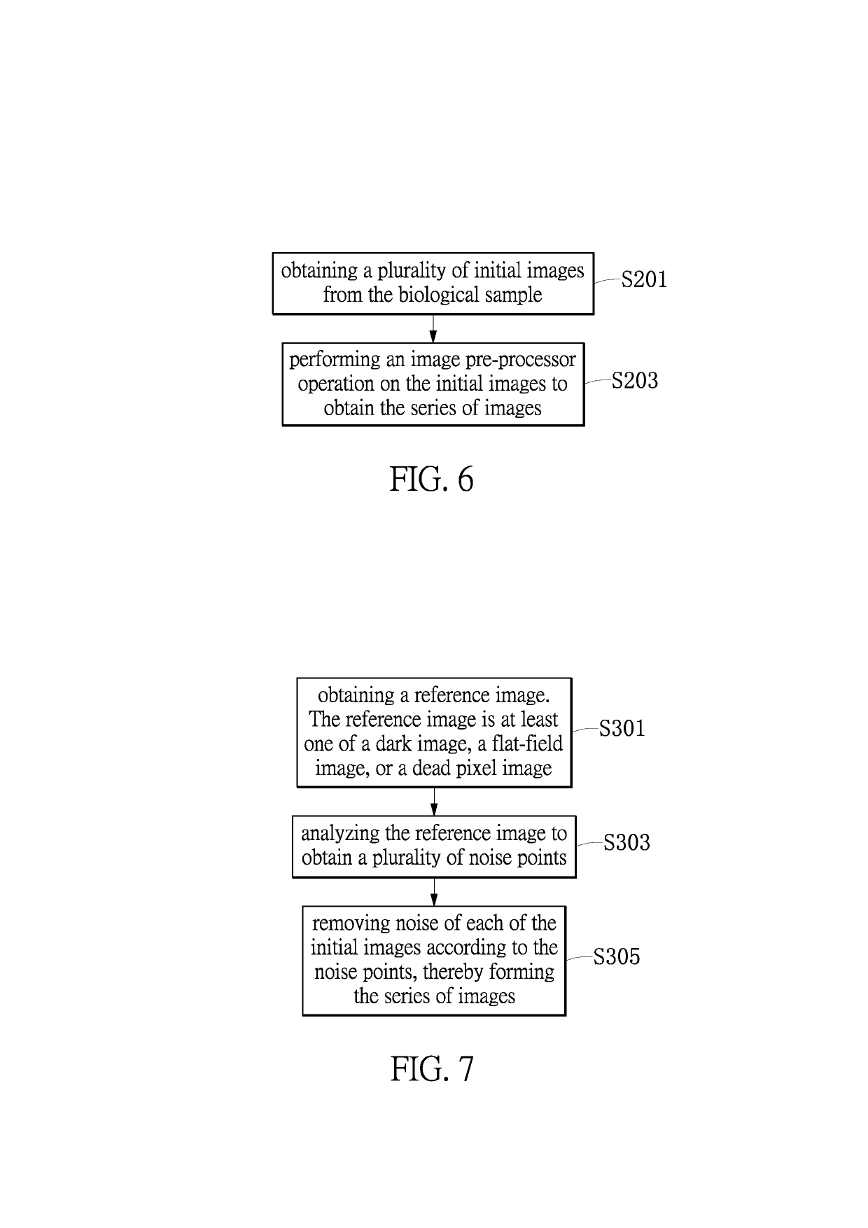

As shown in FIG. 7, in a first aspect, the image pre-processing operation includes:

A step S301 is implemented by obtaining a reference image. The reference image is at least one of a dark image, a flat-field image, or a dead pixel image. The dark image may be captured under completely dark conditions to capture the sensor's thermal noise points. The flat-field image may be captured against a uniform light source to correct for dark corners or brightness non-uniformity caused by optical path inconsistencies. The dead pixel image indicates the location of dead pixels on the sensor.

A step S303 is implemented by analyzing the reference image to obtain a plurality of noise points.

A step S305 is implemented by removing noise of each of the initial images according to the noise points, thereby forming the series of images.

In other words, the image pre-processor 12 first analyzes the reference image to obtain characteristics of the noise points, and performs an algorithmic process on each of the initial images according to the characteristics of the noise points.

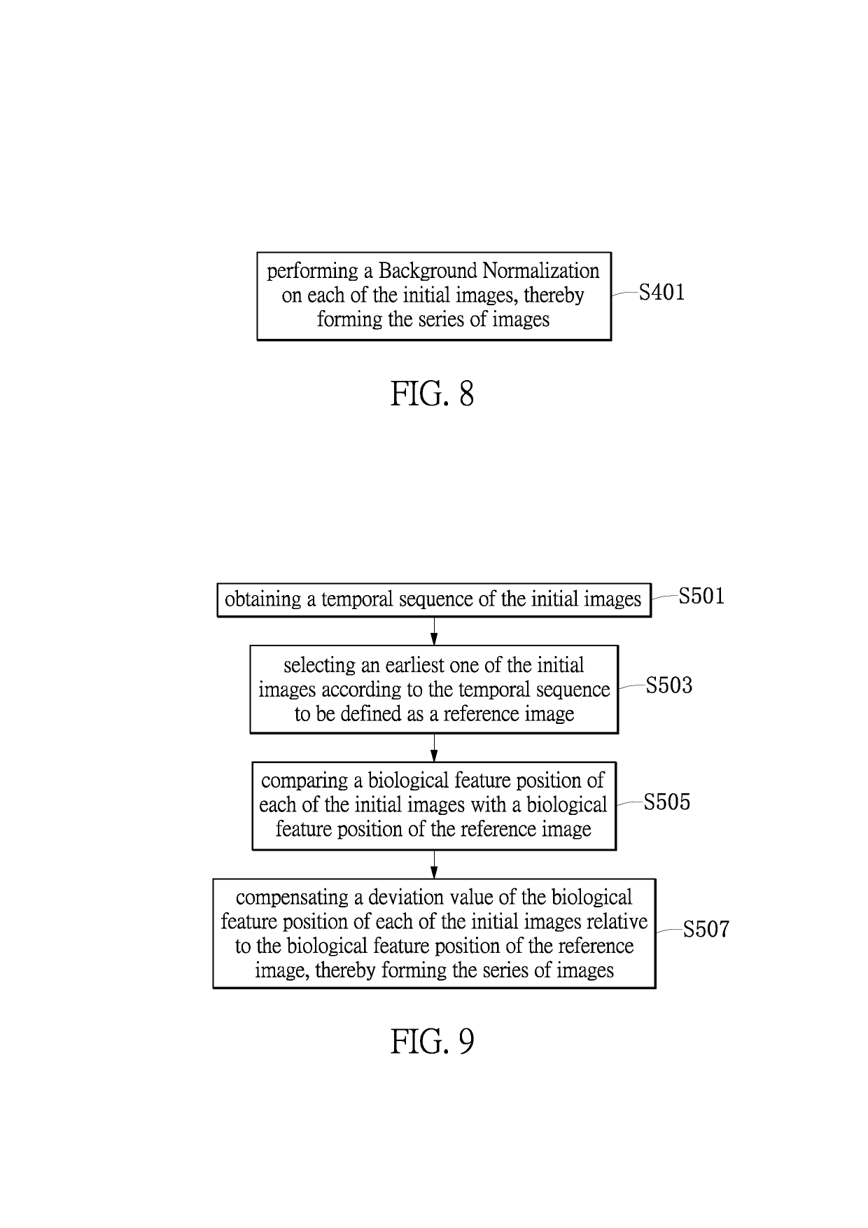

As shown in FIG. 8, in a second aspect, the image pre-processing operation includes:

A step S401 is implemented by performing a Background Normalization on each of the initial images, thereby forming the series of images. The image pre-processing operation in the second aspect is particularly applicable to images with non-uniform background brightness, such as the darker edge phenomenon caused by the meniscus of the culture medium. The image pre-processing operation can estimate and remove the non-uniform background through an algorithm (e.g., a rolling ball algorithm), which can make subsequent cell object detection and segmentation more accurate.

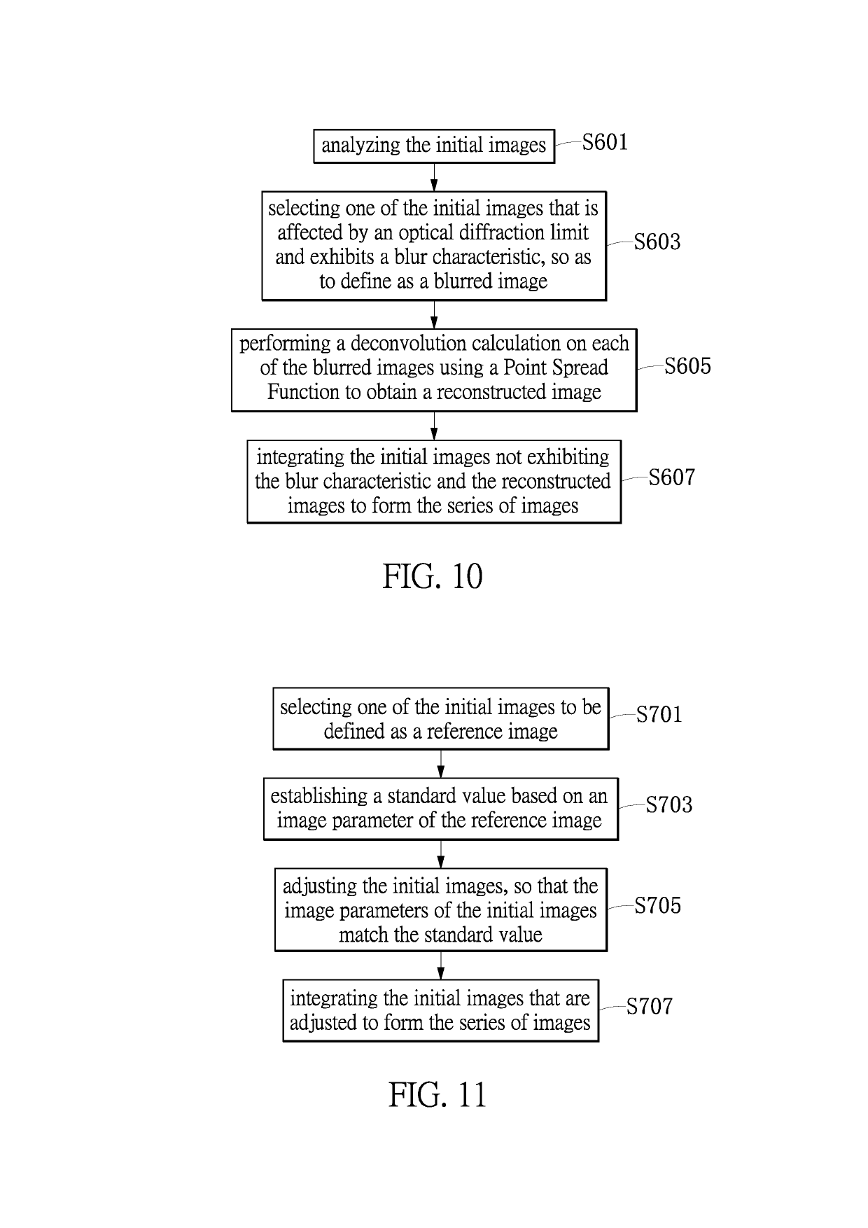

As shown in FIG. 9, in a third aspect, the image pre-processing operation includes:

A step S501 is implemented by obtaining a temporal sequence of the initial images.

A step S503 is implemented by selecting an earliest one of the initial images according to the temporal sequence to be defined as a reference image.

A step S505 is implemented by comparing a biological feature position of each of the initial images with a biological feature position of the reference image.

A step S507 is implemented by compensating a deviation value of the biological feature position of each of the initial images relative to the biological feature position of the reference image, thereby forming the series of images.

In practice, in long-term live cell observation experiments, the biological sample may generate positional drift due to mechanical vibration or cell movement. Thus, the image pre-processing operation may utilize an Image Registration algorithm to compare the biological feature position (e.g., cell nuclei or specific structures) in each of the initial images relative to the position of the reference image, for coordinate compensation. Accordingly, in the series of images after the image pre-processing operation, all cells are in aligned and stable positions.

As shown in FIG. 10, in a fourth aspect, the image pre-processing operation includes:

A step S601 is implemented by analyzing the initial images.

A step S603 is implemented by selecting one of the initial images that is affected by an optical diffraction limit and exhibits a blur characteristic, so as to define as a blurred image.

A step S605 is implemented by performing a deconvolution calculation on each of the blurred images through a Point Spread Function (PSF) to obtain a reconstructed image.

A step S607 is implemented by integrating the initial images not exhibiting the blur characteristic and the reconstructed images to form the series of images.

Specifically, when the size of the biological features being observed is close to the optical diffraction limit, the initial image may exhibit a blur characteristic. At this time, the biological sample analysis system 100A first analyzes and selects the images exhibiting the blur characteristic, and utilizes a known Point Spread Function (PSF) to perform deconvolution processing on the blurred images, thereby reconstructing the reconstructed images that are clearer and richer in detail. Finally, the series of images will be integrated jointly by the initial images not exhibiting the blur characteristic and the reconstructed images.

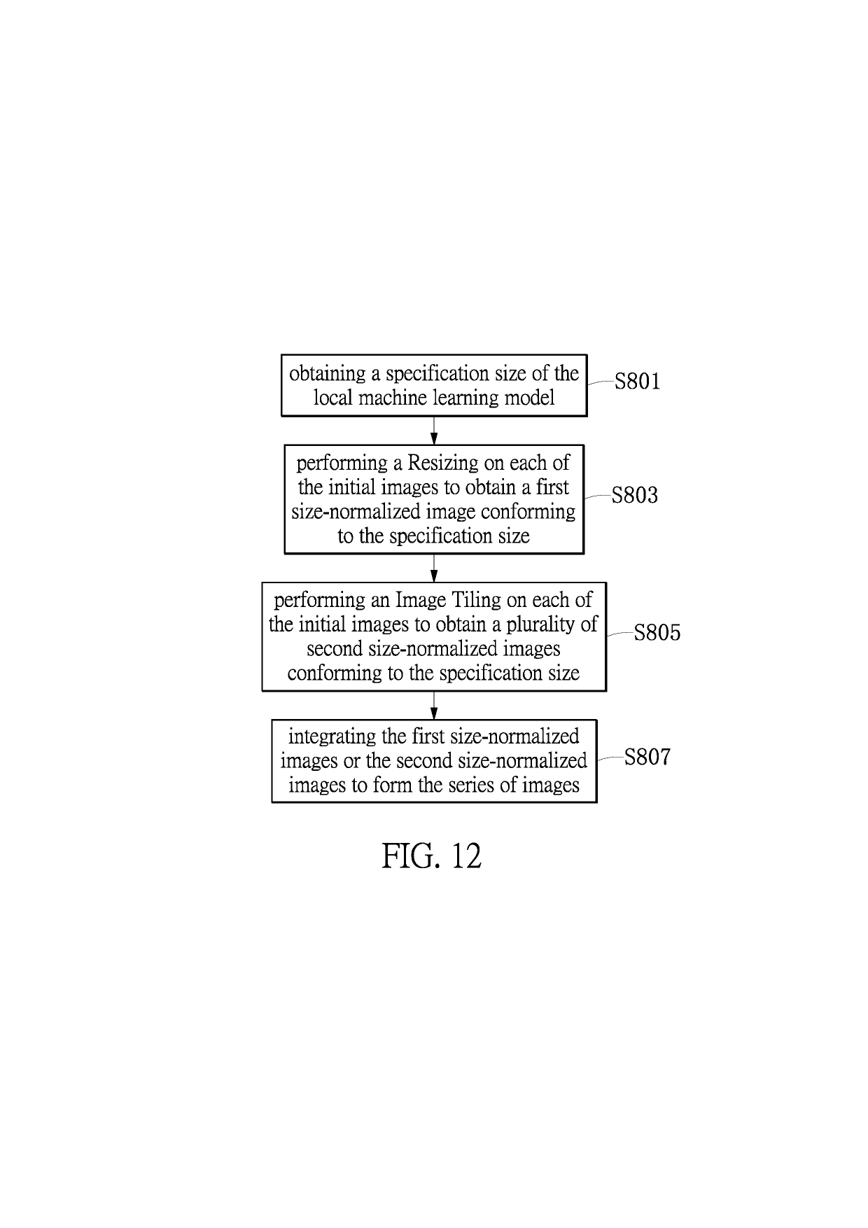

As shown in FIG. 11, in a fifth aspect, the image pre-processing operation includes:

A step S701 is implemented by selecting one of the initial images to be defined as a reference image.

A step S703 is implemented by establishing a standard value based on an image parameter of the reference image.

A step S705 is implemented by adjusting the initial images so that the image parameters of the initial images match the standard value.

A step S707 is implemented by integrating the initial images that are adjusted to form the series of images.

Specifically, in order to ensure consistency of images from different time points or different devices, the biological sample analysis system 100A may select one of the initial images as the reference image, and establish the standard value based on an image parameter of the reference image (e.g., brightness, contrast, color distribution). Next, the other initial images are adjusted so that the image parameters of the other initial images match the standard value as closely as possible, and finally, the adjusted plurality of initial images are integrated into the series of images.

As shown in FIG. 12, in a sixth aspect, the image pre-processing operation includes:

A step S801 is implemented by obtaining a specification size of the local machine learning model.

A step 803 is implemented by performing a resizing on each of the initial images to obtain a first size-normalized image conforming to the specification size. In response to a difference between a size of each of the initial images and the specification size being smaller than a predetermined threshold.

A step 805 is implemented by performing an image tiling on each of the initial images to obtain a plurality of second size-normalized images conforming to the specification size. In response to the difference between the size of each of the initial images and the specification size being larger than the predetermined threshold.

A step 807 is implemented by integrating the first size-normalized images or the second size-normalized images to form the series of images.

Specifically, a machine learning model typically requires input images of a fixed size. However, each of the imaging devices 1 may output the initial images with different resolutions. For this purpose, the biological sample analysis system 100A first obtains the specification size of a local machine learning model (run by the local computing device 2). In response to a difference between the size of the initial images and the specification size being smaller than a predetermined threshold, the initial images are subjected to resizing to obtain images conforming to the size (i.e., the first size-normalized images). However, when the difference is larger than the predetermined threshold (i.e., the initial images are much larger than the specification size), direct scaling down of the initial images may lose excessive details. Therefore, the biological sample analysis system 100A may perform image tiling on the initial images, so that each of the initial images is segmented into a plurality of small block images conforming to the specification size (i.e., the second size-normalized images). Finally, the size-normalized images are integrated to form the series of images for analysis by the local machine learning model.

It should be noted that, in practice, the image pre-processing operation may select at least one of the first aspect to the sixth aspect based on the conditions of the initial images or other requirements; that is, the image pre-processing operation may also include all the steps of the first aspect to the sixth aspect.

### Fourth Embodiment

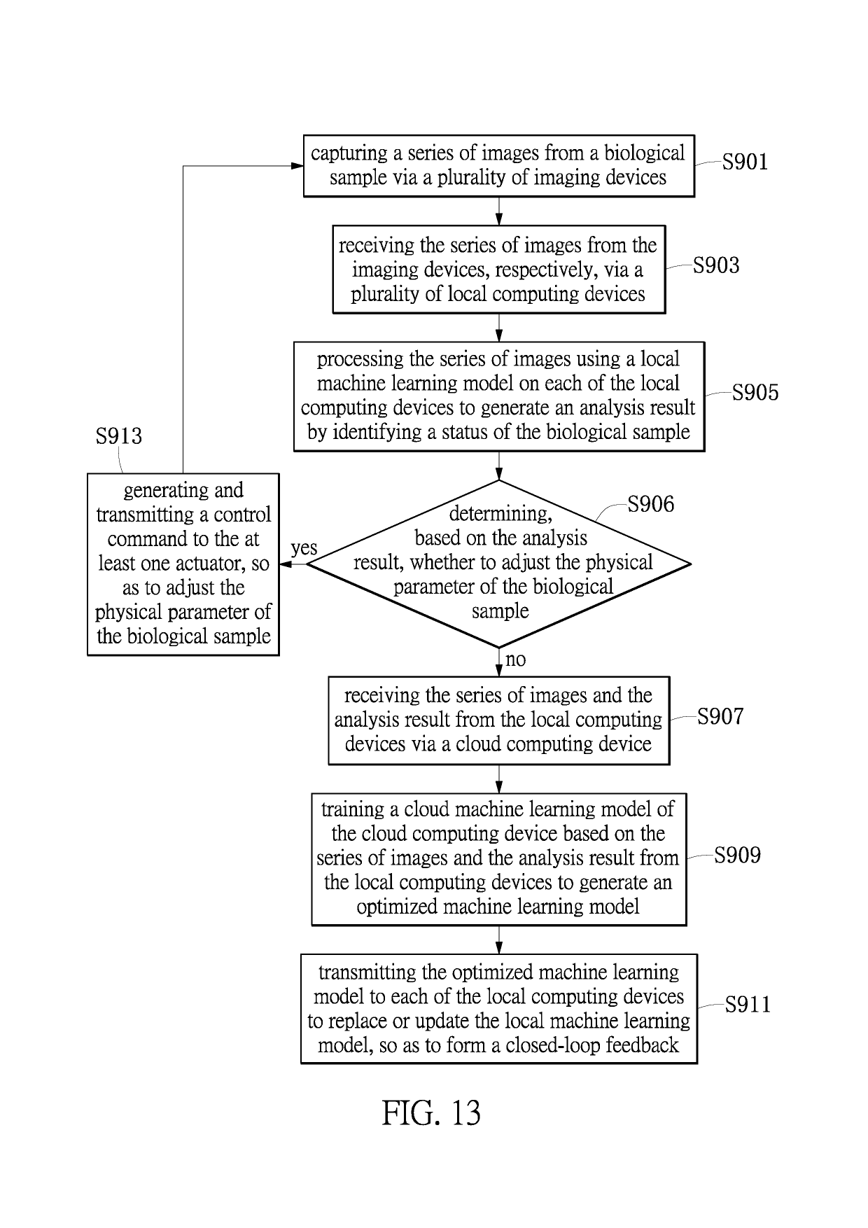

Referring to FIG. 13, a fourth embodiment of the present disclosure provides a biological sample analysis method. The present embodiment is similar to the third embodiment, and the similarities between the present embodiment and the third embodiment will not be repeated herein. The differences of the present embodiment from the third embodiment are mainly as follows.

The biological sample analysis method includes steps S901 to S911. The steps S901 to S911 are the same as steps S101 to S111 in the third embodiment and are therefore not redundantly described herein. In addition, the biological sample analysis method in this embodiment may further include the following steps after step S905:

A step S906 is implemented by determining, based on the analysis result, whether to adjust the physical parameter of the biological sample.

A step S913 is implemented by generating and transmitting a control command to the at least one actuator, so as to adjust the physical parameter of the biological sample.

In practice, after completing step S905, the process proceeds to the decision step S906 to determine whether to adjust a physical parameter of the biological sample based on the analysis result. For example, if it is determined in step S906 that the ambient temperature of the biological sample is too low (i.e., the decision is "yes"), then step S913 is executed to adjust the physical parameter. Conversely, if no adjustment is needed (i.e., the decision is "no"), the process proceeds to step S907.

The at least one actuator may be, for example: a temperature controller for precisely controlling temperature, a microfluidic pump for conveying liquid, or a motion actuator for moving a sample stage.

For example, when the local machine learning model LM analyzes the images and determines that the growth rate of the cell culture is irregular, possibly from the fluctuations in incubator temperature, the control command can be automatically sent to the temperature controller (i.e., the actuator) to perform temperature regulation. Taking another example, when the analysis result shows that the fluorescence intensity change of the drug reaction is slowing down, the control command can be automatically sent to adjust the flow rate of the microfluidic pump (i.e., the actuator) to change the drug concentration.

Accordingly, the biological sample analysis method realizes a closed-loop automation from "analysis" to "manipulation" to adjust the physical parameters of the biological sample in real time, thereby optimizing the experimental process and reducing human intervention and errors.

### Beneficial Effects of the Embodiments

In conclusion, in the biological sample analysis system and the biological sample analysis method provided by the present disclosure, by virtue of “processing the series of images using a local machine learning model to generate an analysis result by identifying a status of the biological sample,” “training a cloud machine learning model based on the series of images and the analysis result from the local computing devices to generate an optimized machine learning model,” and “transmitting the optimized machine learning model to each of the local computing devices to replace or update the local machine learning model, so as to form a closed-loop feedback,” the biological sample analysis system and the biological sample analysis method can significantly enhance model optimization efficiency.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A biological sample analysis system, comprising:
a plurality of imaging devices configured to capture a series of images from a biological sample;
a plurality of local computing devices respectively and communicatively coupled to the imaging devices, wherein each of the local computing devices includes a processor and a data storage, and the data storage is configured to store a plurality of instructions, and wherein, when the instructions are executed by the processor, a plurality of actions performed by the processor includes:
receiving the series of images from a corresponding one of the imaging devices; and
processing the series of images using a local machine learning model to generate an analysis result by identifying a status of the biological sample; and
a cloud computing device communicatively coupled to each of the local computing devices, wherein the cloud computing device performs a plurality of actions including:
receiving the series of images and the analysis result from the local computing devices;
training a cloud machine learning model based on the series of images and the analysis result from the local computing devices to generate an optimized machine learning model; and
transmitting the optimized machine learning model to each of the local computing devices to replace or update the local machine learning model, so as to form a closed-loop feedback.

2. The biological sample analysis system according to claim 1, further comprising a plurality of automation devices communicatively coupled to each of the local computing devices, wherein each of the automation devices includes at least one actuator, and the at least one actuator is configured to physically manipulate the biological sample and wherein, when the instructions are executed by the processor, the actions performed by the processor further includes: generating and transmitting a control command based on the analysis result to the at least one actuator of a corresponding one of the automation devices to adjust a physical parameter of the biological sample.

3. The biological sample analysis system according to claim 1, wherein each of the imaging devices includes:
an image acquirer configured to obtain a plurality of initial images from the biological sample; and
an image pre-processor connected to the image acquirer, wherein the image pre-processor performs an image pre-processing operation on the initial images to obtain the series of images.

4. The biological sample analysis system according to claim 2, wherein the image pre-processing operation includes:
obtaining a reference image, wherein the reference image is at least one of a dark image, a flat-field image, or a dead pixel image;
analyzing the reference image to obtain a plurality of noise points; and
removing noise of each of the initial images according to the noise points, thereby forming the series of images.

5. The biological sample analysis system according to claim 2, wherein the image pre-processing operation includes:
performing a background normalization on each of the initial images, thereby forming the series of images.

6. The biological sample analysis system according to claim 2, wherein the image pre-processing operation includes:
obtaining a temporal sequence of the initial images;
selecting an earliest one of the initial images according to the temporal sequence to be defined as a reference image;
comparing a biological feature position of each of the initial images with a biological feature position of the reference image; and
compensating a deviation value of the biological feature position of each of the initial images relative to the biological feature position of the reference image, thereby forming the series of images.

7. The biological sample analysis system according to claim 2, wherein the image pre-processing operation includes:
analyzing the initial images;
selecting one of the initial images that is affected by an optical diffraction limit and exhibits a blur characteristic, so as to define as a blurred image;
performing a deconvolution calculation on each of the blurred images using a point spread function to obtain a reconstructed image; and
integrating the initial images not exhibiting the blur characteristic and the reconstructed images to form the series of images.

8. The biological sample analysis system according to claim 2, wherein the image pre-processing operation includes:
selecting one of the initial images to be defined as a reference image;
establishing a standard value based on an image parameter of the reference image;
adjusting the initial images, so that the image parameters of the initial images match the standard value; and
integrating the initial images that are adjusted to form the series of images.

9. The biological sample analysis system according to claim 2, wherein the image pre-processing operation includes:
obtaining a specification size of the local machine learning model;
performing a resizing on each of the initial images to obtain a first size-normalized image conforming to the specification size, in response to a difference between a size of each of the initial images and the specification size being smaller than a predetermined threshold;
performing an image tiling on each of the initial images to obtain a plurality of second size-normalized images conforming to the specification size, in response to the difference between the size of each of the initial images and the specification size being larger than the predetermined threshold; and
integrating the first size-normalized images or the second size-normalized images to form the series of images.

10. A biological sample analysis method, comprising:
capturing a series of images from a biological sample via a plurality of imaging devices;
receiving the series of images from the imaging devices, respectively, via a plurality of local computing devices;
processing the series of images using a local machine learning model on each of the local computing devices to generate an analysis result by identifying a status of the biological sample;
receiving the series of images and the analysis result from the local computing devices via a cloud computing device;
training a cloud machine learning model of the cloud computing device based on the series of images and the analysis result from the local computing devices to generate an optimized machine learning model; and
transmitting the optimized machine learning model to each of the local computing devices to replace or update the local machine learning model, so as to form a closed-loop feedback.

11. The biological sample analysis method according to claim 10, further comprising:
determining, based on the analysis result, whether to adjust the physical parameter of the biological sample;
generating and transmitting a control command based on the analysis result to the at least one actuator, so as to adjust a physical parameter of the biological sample.

12. The biological sample analysis method according to claim 10, wherein a step of capturing the series of images further includes:
obtaining a plurality of initial images from the biological sample; and
performing an image pre-processing operation on the initial images to obtain the series of images.

13. The biological sample analysis method according to claim 12, wherein the image pre-processing operation includes:
obtaining a reference image, wherein the reference image is at least one of a dark image, a flat-field image, or a dead pixel image;
analyzing the reference image to obtain a plurality of noise points; and
removing noise of each of the initial images according to the noise points, thereby forming the series of images.

14. The biological sample analysis method according to claim 12, wherein the image pre-processing operation includes:
performing a background normalization on each of the initial images, thereby forming the series of images.

15. The biological sample analysis method according to claim 12, wherein the image pre-processing operation includes:
obtaining a temporal sequence of the initial images;
selecting an earliest one of the initial images according to the temporal sequence to be defined as a reference image;
comparing a biological feature position of each of the initial images with a biological feature position of the reference image; and
compensating a deviation value of the biological feature position of each of the initial images relative to the biological feature position of the reference image, thereby forming the series of images.

16. The biological sample analysis method according to claim 12, wherein the image pre-processing operation includes:
analyzing the initial images;
selecting one of the initial images that is affected by an optical diffraction limit and exhibits a blur characteristic, so as to define as a blurred image;
performing a deconvolution calculation on each of the blurred images using a Point Spread Function to obtain a reconstructed image; and
integrating the initial images not exhibiting the blur characteristic and the reconstructed images to form the series of images.

17. The biological sample analysis method according to claim 12, wherein the image pre-processing operation includes:
selecting one of the initial images to be defined as a reference image;
establishing a standard value based on an image parameter of the reference image;
adjusting the initial images, so that the image parameters of the initial images match the standard value; and
integrating the initial images that are adjusted to form the series of images.

18. The biological sample analysis method according to claim 12, wherein the image pre-processing operation includes:
obtaining a specification size of the local machine learning model;
performing a resizing on each of the initial images to obtain a first size-normalized image conforming to the specification size, in response to a difference between a size of each of the initial images and the specification size being smaller than a predetermined threshold;
performing an image tiling on each of the initial images to obtain a plurality of second size-normalized images conforming to the specification size, in response to the difference between the size of each of the initial images and the specification size being larger than the predetermined threshold; and
integrating a plurality of first size-normalized images or the second size-normalized images to form the series of images.
